(19) United States
(12) Patent Application Publication
(10) Pub. No.: US 2026/0147130 A1
(43) Pub. Date: May 28, 2026

(54) LITHOFACIES ANALYSIS SYSTEM AND METHOD BASED ON SHALE GEOLOGICAL - MECHANICAL COUPLED LITHOFACIES CLASSIFICATION SYSTEM

(71) Applicants: Southwest Petroleum University, Chengdu City (CN); Chengdu University of Technology, Chengdu City (CN)

(72) Inventors: Chenghua OU, Chengdu City (CN); Minghao CHEN, Chengdu City (CN); Haiyan ZHU, Chengdu City (CN); Chaochun LI, Chengdu City (CN)

(21) Appl. No.: 19/049,404

(22) Filed: Feb. 10, 2025

(30) Foreign Application Priority Data
Nov. 26, 2024 (CN) 202411699733.9

(51) Int. Cl. G01V 1/28

(52) U.S. Cl. CPC G01V 1/282; G01V 2210/6242; G01V 2210/6652

(57) ABSTRACT

Provided are a lithofacies analysis system and method based on a shale geological-mechanical coupled lithofacies classification system, which relate to the field of shale lithofacies analysis. The lithofacies analysis system includes a system construction module that determines a geological-mechanical coupled lithofacies classification system based on information data of a data acquisition module. A prediction module determines single-well lithofacies prediction information. A feedback adjustment module performs feedback adjustment on the single-well lithofacies prediction information based on a set range of a rock mechanics and geostress parameter and acquire adjustment information. A three-dimensional model construction module performs, by a genetic algorithm, seismic attribute embedding and integrated inversion based on seismic attribute data and the adjustment information, and constructs, by a collaborative Kriging method, a three-dimensional model for well-seismic collaborative modeling of geological-mechanical coupled lithofacies.

### CROSS REFERENCE TO RELATED APPLICATION

This patent application claims the benefit and priority of Chinese Patent Application No. 2024116997339, filed with the China National Intellectual Property Administration on Nov. 26, 2024, the disclosure of which is incorporated by reference herein in its entirety as part of the present application.

### TECHNICAL FIELD

The present disclosure relates to the field of shale lithofacies analysis, and in particular to a lithofacies analysis system and method based on a shale geological-mechanical coupled lithofacies classification system.

### BACKGROUND

With the long-term exploitation of conventional oil and gas reservoirs and the continuous reduction of recoverable reserves around the world, people are gradually investing various resources into the exploration and development of unconventional oil and gas reservoirs. Among them, shale oil and gas reservoirs have become a key research object for many scholars and practitioners. The abundant resources of shale oil and gas have created many shale oil and gas producing countries. For example, the “shale gas revolution” transformed the United States from a major natural gas importer to an exporter. As the largest shale gas producer outside of North America, China has deployed large-scale shale gas production areas in multiple regions based on the Sichuan Basin and adjacent areas, forming a mature large-scale industrial production model for shale gas. For the abundant medium and shallow shale oil and gas resources in the United States and the deep and ultra-deep shale oil and gas resources with enormous development potential in China, ultra-long horizontal wells+large-scale refracturing has always been a common and effective means of shale oil and gas exploration and development. During the continuous implementation of this means, the geological-mechanical coupled characteristics of shale have gradually attracted people's attention.

Three-dimensional geological-mechanical modeling of shale oil and gas reservoirs can provide a wealth of understanding of geological-mechanical coupled characteristics of the formation for the oil and gas development sites, thereby improving the engineering efficiency of large-scale development of shale oil and gas resources. At present, geological modeling can improve the accuracy of the constructed model through sedimentary facies control. However, rock mechanics and geostress parameter modeling lacks an effective facies control solution to improve the accuracy of the model. It still uses deterministic interpolation or stochastic modeling methods, which leads to poor reliability of the constructed geological-mechanical property model, making it not conform to the geological-mechanical coupled characteristics and laws of underground rock masses. To solve the above problems, it is necessary to deeply explore the controlled factors of geological-mechanical characteristics of shale rock masses.

At present, there is relatively little or insufficient research on the geological-mechanical coupled characteristics. In addition, in most cases, research on geological-mechanical characteristics is artificially split. That is to say, the influence of mechanical factors is neglected in the research of geological properties or the objective existence of geological factors is not considered in the analysis of mechanical characteristics, resulting in significant deviations between the research results and actual underground conditions. The literature “Influence of Temperature on Rock Mechanics Properties and Borehole Wall Stability” (published by Jia Lichun, Chen Dong, and Huang Bing in September 2017) conducted triaxial compression experiments on rocks under different temperature conditions, and analyzed the variation laws between borehole wall collapse pressure, fracture pressure, and temperature. This method combines theory and practice to fully explain the relationship between temperature and rock mechanics, but lacks exploration of core geological factors. The literature “Weakening Law of Shale Strength and Its Effect on Wall Stability of Horizontal Well” reveals the weakening law of shale shear strength under the influence of drilling fluid based on direct shear tests, and analyzes the influence of shale weakening on the collapse pressure of horizontal wells. This method focuses on discussing the influence of rock mechanics properties on borehole wall stability, with less exploration of geological genesis, and only involves the rock mechanics parameter of shear strength, lacking exploration of other mechanics parameters. The literature “Modeling of Rock Mechanics Parameters in the Tight Reservoir of Fuyu Oil Layer in Well Area T30 of Daqing Oilfield” (published by Guo Siqiang in October 2020) calculated the rock mechanics and geostress parameters of a single well from logging data, and constructed a three-dimensional model of rock mechanics and geostress parameters through geostatistical methods. This method mainly adopts a stochastic modeling approach, and the accuracy of the constructed model deviates from the real situation to some extent. In view of the above problems, it is crucial to analyze and determine the three-dimensional spatial distribution heterogeneity of geological-mechanical characteristics of shale beds, thereby providing a basis for the exploration and development of artificial oil and gas reservoirs in production areas.

### SUMMARY

An objective of the present disclosure is to provide a lithofacies analysis system and method based on a shale geological-mechanical coupled lithofacies classification system, which can achieve the analysis and determination of the three-dimensional spatial distribution heterogeneity of geological-mechanical characteristics of shale beds.

To achieve the above objective, the present disclosure provides the following technical solutions.

A first aspect of the present disclosure provides a lithofacies analysis system based on a shale geological-mechanical coupled lithofacies classification system, including a data acquisition module, configured to acquire information data, including geological lithofacies data and in-situ mechanics parameter data.

A system construction module is connected to the data acquisition module, and configured to determine a geological-mechanical coupled lithofacies classification system based on the information data.

A prediction module is connected to the system construction module, and configured to perform, by the geological-mechanical coupled lithofacies classification system, single-well quantitative prediction of lithofacies based on logging data, and acquire single-well lithofacies prediction information, where the single-well lithofacies prediction information refers to a prediction result of single-well geological-mechanical coupled lithofacies in an entire wellbore space within a range of a bed of interest, and is configured to characterize a facies sequence change characteristic of the single-well geological-mechanical coupled lithofacies along a wellbore.

A feedback adjustment module is connected to the prediction module, and configured to perform feedback adjustment on the single-well lithofacies prediction information based on a set range of a rock mechanics and geostress parameter, and acquire adjustment information.

A three-dimensional model construction module is connected to the feedback adjustment module, and configured to perform, by a genetic algorithm, seismic attribute embedding and integrated inversion based on seismic attribute data and the adjustment information, and construct, by a collaborative Kriging method, a three-dimensional model for well-seismic collaborative modeling of the geological-mechanical coupled lithofacies, where the three-dimensional model is a three-dimensional physical simulation model constructed based on an inherent relationship between respective properties of a geological lithofacies and the geological-mechanical coupled lithofacies, and configured to characterize a mechanical heterogeneity difference and distribution law of the geological lithofacies.

A parameter model determination module is connected to the three-dimensional model construction module, and configured to determine, by a layer control-facies control constraint, a geological-mechanical coupled lithofacies control rock mechanics and geostress parameter model based on the three-dimensional model, where the parameter model is configured to characterize three-dimensional spatial distribution heterogeneity of a geological-mechanical characteristic of a shale bed, thereby providing a basis for the exploration and development of an artificial oil and gas reservoir in a production area.

A second aspect of the present disclosure provides a lithofacies analysis method based on a shale geological-mechanical coupled lithofacies classification system, including acquiring information data, including geological lithofacies data and in-situ mechanics parameter data.

A geological-mechanical coupled lithofacies classification system is determined based on the information data.

Single-well quantitative prediction of lithofacies is performed by the geological-mechanical coupled lithofacies classification system, based on logging data, and single-well lithofacies prediction information is acquired, where the single-well lithofacies prediction information refers to a prediction result of single-well geological-mechanical coupled lithofacies in an entire wellbore space within a range of a bed of interest, and is configured to characterize a facies sequence change characteristic of the single-well geological-mechanical coupled lithofacies along a wellbore.

A feedback adjustment is performed on the single-well lithofacies prediction information based on a set range of a rock mechanics and geostress parameter, and acquiring adjustment information.

Seismic attribute embedding and integrated inversion is performed by a genetic algorithm based on seismic attribute data and the adjustment information, and constructing, by a collaborative Kriging method, a three-dimensional model for well-seismic collaborative modeling of the geological-mechanical coupled lithofacies, where the three-dimensional model is a three-dimensional physical simulation model constructed based on an inherent relationship between respective properties of a geological lithofacies and the geological-mechanical coupled lithofacies, and configured to characterize a mechanical heterogeneity difference and distribution law of the geological lithofacies.

A geological-mechanical coupled lithofacies control rock mechanics and geostress parameter model is determined by a layer control-facies control constraint based on the three-dimensional model, where the parameter model is configured to characterize three-dimensional spatial distribution heterogeneity of a geological-mechanical characteristic of a shale bed, thereby providing a basis for the exploration and development of an artificial oil and gas reservoir in a production area.

According to specific embodiments provided by the present disclosure, the present has the following technical effects:

The present disclosure provides a lithofacies analysis system and method based on a shale geological-mechanical coupled lithofacies classification system. As the shale rock mass buried deep underground is a geological-mechanical coupled system, studying shale rock mass requires taking into account the respective controlled factors of geology and mechanics, as well as exploring the inherent relationship between geology and mechanics. In order to improve the accuracy of the three-dimensional model of rock mechanics and geostress parameters, it is necessary to select mechanics parameters that are significantly correlated with geological properties, and form a type of geological-mechanical coupled control factor to participate in the modeling of mechanics parameters, thereby achieving the goal of improving the accuracy of the mechanical model. On the basis of geological lithofacies classification and identification of shale, the present disclosure systematically carries out rock mechanics and geostress characteristic analysis and identification of the geological lithofacies, and further proposes the construction of a geological-mechanical coupled lithofacies classification system. In this way, the present disclosure forms a comprehensive single-well identification and three-dimensional prediction technology process to characterize the distribution heterogeneity of geological-mechanical characteristics of shale beds in a three-dimensional space, providing a basis for production areas for the exploration and development of artificial oil and gas reservoirs.

### BRIEF DESCRIPTION OF THE DRAWINGS

FIG. 1 is a structural diagram of a lithofacies analysis system based on a shale geological-mechanical coupled lithofacies classification system;

FIG. 2 is a technical flowchart of lithofacies analysis based on the shale geological-mechanical coupled lithofacies classification system;

FIG. 3 is a flowchart of acquiring a geological lithofacies and arranging a mechanics parameter;

FIG. 4 is a flowchart of selecting a difference sensitive rock mechanics and geostress parameter;

FIG. 5 is a schematic diagram of a classification chart for geological-mechanical coupled lithofacies of carbon-rich medium-high-porosity siliceous shale;

FIG. 6 is a schematic diagram of a classification chart for geological-mechanical coupled lithofacies of carbon-rich medium-high-porosity calcium-bearing mud-bearing siliceous shale;

FIG. 7 is a schematic diagram of a classification chart for geological-mechanical coupled lithofacies of medium-high-carbon medium-high-porosity siliceous shale;

FIG. 8 is a schematic diagram of a classification chart for geological-mechanical coupled lithofacies of medium-low-carbon medium-low-porosity calcium-bearing argillaceous siliceous shale;

FIG. 9 is a schematic diagram of a classification chart for geological-mechanical coupled lithofacies of medium-high-carbon medium-high-porosity mud-bearing siliceous shale;

FIG. 10 is a comprehensive column chart of a quantitative prediction result of a typical single-well geological-mechanical coupled lithofacies; where A1-System, A2-Series, A3-Formation, A4-Single-layer, A5-Depth, A6-50 Interval transit time 100, A7-50 Natural gamma 100, A8-0 Compensated neutron 25, A9-2.4 Density 2.75, A10-0 Tensile strength 0.6, A11-0 Shear strength 0.4, A12-0.7 Young's modulus 0.9, A13-Geological-mechanical coupled lithofacies, A14-Geological lithofacies, A15-Microfacies, A16-Subfacies, A17-Facies, A18-Silurian, A19-Lower, A20-Longmaxi, A21-Ordovician, A22-Upper, A23-Wufeng, A24-Medium-low-carbon medium-low-porosity calcium-bearing argillaceous siliceous shale with strong tensile toughness, A25-Brittle medium-low-carbon medium-low-porosity calcium-bearing argillaceous siliceous shale, A26-Medium-low-carbon medium-low-porosity calcium-bearing argillaceous siliceous shale with strong tensile toughness, A27-Brittle medium-low-carbon medium-low-porosity calcium-bearing argillaceous siliceous shale, A28-Medium-high-carbon medium-high-porosity mud-bearing siliceous shale with strong tensile toughness, A29-Brittle medium-high-carbon medium-high-porosity mud-bearing siliceous shale, A30-Medium-high-carbon medium-high-porosity mud-bearing siliceous shale with strong tensile toughness, A31-Brittle carbon-rich medium-high-porosity siliceous shale, A32-Carbon-rich medium-high-porosity siliceous shale with strong tensile toughness, A33-Medium-high-carbon medium-high-porosity siliceous shale with strong tensile toughness, A34-Brittle carbon-rich medium-high-porosity calcareous and argillaceous siliceous shale, A35-Carbon-rich medium-high-porosity calcium-bearing mud-bearing siliceous shale with strong tensile toughness, A36-Medium-low-carbon medium-low-porosity calcium-bearing mud-bearing siliceous shale with strong shear toughness, A37-Medium-low-carbon medium-low-porosity calcium-bearing mud-bearing siliceous shale with strong tensile toughness, A38-Medium-low-carbon medium-low-porosity calcareous and argillaceous siliceous shale, A39-Medium-high-carbon medium-high-porosity mud-bearing siliceous shale, A40-Carbon-rich medium-high-porosity siliceous shale, A41-Medium-high-carbon medium-high-porosity siliceous shale, A42-Carbon-rich medium-high-porosity calcium-bearing mud-bearing siliceous shale, A43-Medium-low-carbon medium-low-porosity calcium-bearing mud-bearing siliceous shale, A44-Hybrid terrestrial facies, A45-Siliceous terrestrial facies, A46-Hybrid terrestrial facies, A27-Deep-water terrestrial facies, A48-Terrestrial facies, A49-Medium-low-carbon medium-low-porosity calcium-bearing argillaceous siliceous shale with strong tensile toughness;

FIG. 11 is a relative acoustic impedance-genetic inversion profile of a single-well lithofacies;

FIG. 12 is a schematic diagram of a three-dimensional inversion data volume of a geological lithofacies;

FIG. 13 is a schematic diagram of a three-dimensional inversion data volume of a geological-mechanical coupled lithofacies;

FIG. 14 is a schematic diagram of a three-dimensional model of a first geological lithofacies;

FIG. 15 is a schematic diagram of a three-dimensional model of a second geological lithofacies;

FIG. 16 is a profile of a first geological lithofacies;

FIG. 17 is a profile of a second geological lithofacies;

FIG. 18 is a schematic diagram of a three-dimensional model of a first geological-mechanical coupled lithofacies;

FIG. 19 is a schematic diagram of a three-dimensional model of a second geological-mechanical coupled lithofacies;

FIG. 20 is a schematic diagram of a three-dimensional model of a third geological-mechanical coupled lithofacies;

FIG. 21 is a profile of a geological-mechanical coupled lithofacies;

FIG. 22 is a schematic diagram of a random interpolation three-dimensional model;

FIG. 23 is a schematic diagram of a geological-mechanical coupled lithofacies control model;

FIG. 24 is a profile of a random interpolation model; and

FIG. 25 is a profile of a facies control model.

### DETAILED DESCRIPTION OF THE EMBODIMENTS

The content mentioned in the present disclosure was practically applied to a shale gas production area in western China, expanding to cover the entire study area based on a single well. The present disclosure reveals the differences and distribution laws of different geological-mechanical coupled lithofacies in the study area, and forms a comprehensive and accurate understanding of formation lithofacies, rock mechanics, and geostress characteristics of the study area. Therefore, the present disclosure provides a method and technical support for facies control geological-mechanical modeling. This technology process can fully characterize the geological and mechanical characteristics of shale lithofacies, and the lithofacies-rock mechanics characterization of sandstone, carbonate rock, and other rock masses can also refer to this technology process.

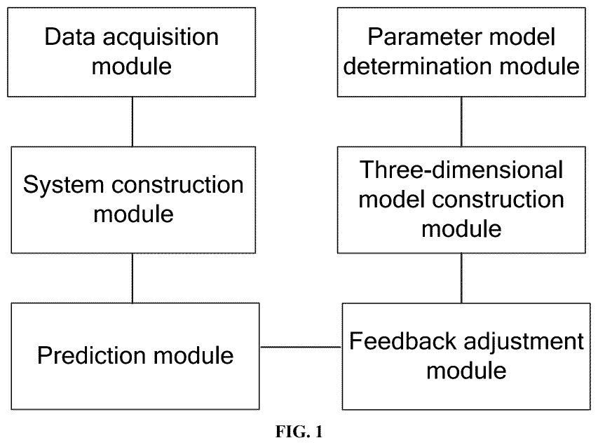

As shown in FIG. 1, the present disclosure provides a lithofacies analysis system based on a shale geological-mechanical coupled lithofacies classification system, including: a data acquisition module, a system construction module, a prediction module, a feedback adjustment module, a three-dimensional model construction module, and a parameter model determination module.

The data acquisition module is configured to acquire information data, including geological lithofacies data and in-situ mechanics parameter data.

The system construction module is connected to the data acquisition module, and configured to determine a geological-mechanical coupled lithofacies classification system based on the information data. The geological-mechanical coupled lithofacies classification system includes a geological-mechanical coupled lithofacies classification chart and a parameter division standard table of the geological-mechanical coupled lithofacies classification system.

The prediction module is connected to the system construction module, and configured to perform, by the geological-mechanical coupled lithofacies classification system, single-well quantitative prediction of lithofacies based on logging data, and acquire single-well lithofacies prediction information, where the single-well lithofacies prediction information refers to a prediction result of single-well geological-mechanical coupled lithofacies in an entire wellbore space within a range of a bed of interest, and is configured to characterize a facies sequence change characteristic of the single-well geological-mechanical coupled lithofacies along a wellbore.

The feedback adjustment module, connected to the prediction module, and configured to perform feedback adjustment on the single-well lithofacies prediction information based on a set range of a rock mechanics and geostress parameter, and acquire adjustment information.

The three-dimensional model construction module is connected to the feedback adjustment module, and configured to perform, by a genetic algorithm, seismic attribute embedding and integrated inversion based on seismic attribute data and the adjustment information, and construct, by a collaborative Kriging method, a three-dimensional model for well-seismic collaborative modeling of the geological-mechanical coupled lithofacies, where the three-dimensional model is a three-dimensional physical simulation model constructed based on an inherent relationship between respective properties of a geological lithofacies and the geological-mechanical coupled lithofacies, and configured to characterize a mechanical heterogeneity difference and distribution law of the geological lithofacies.

The parameter model determination module is connected to the three-dimensional model construction module, and configured to determine, by a layer control-facies control constraint, a geological-mechanical coupled lithofacies control rock mechanics and geostress parameter model based on the three-dimensional model, where the parameter model is configured to characterize three-dimensional spatial distribution heterogeneity of a geological-mechanical characteristic of a shale bed, thereby providing a basis for the exploration and development of an artificial oil and gas reservoir in a production area.

The system construction module includes: a processing sub-module, a parameter determination sub-module, a cluster core determination sub-module, an analysis sub-module, and a system determination sub-module.

The processing sub-module is connected to the data acquisition module, and configured to perform data arrangement and singularity removal based on the information data, a positional correspondence principle or similarity and contiguity principle, and a logging response characteristic, so as to acquire arranged data.

The parameter determination sub-module is connected to the processing sub-module, and configured to determine a difference sensitive rock mechanics parameter based on the arranged data, where the difference sensitive rock mechanics parameter includes tensile strength, shear strength, and Young's modulus.

The cluster core determination sub-module is connected to the data acquisition module and the parameter determination sub-module separately, and configured to determine a geological-mechanical coupled lithofacies cluster core based on the information data and the difference sensitive rock mechanics parameter.

The analysis sub-module is connected to the cluster core determination sub-module, and configured to analyze a boundary and an intersection range of geological-mechanical coupled lithofacies clusters based on the geological-mechanical coupled lithofacies cluster core and determine the boundary and range of the geological-mechanical coupled lithofacies clusters.

The system determination sub-module is connected to the analysis sub-module, and configured to draw the geological-mechanical coupled lithofacies classification chart based on the boundary and range of the geological-mechanical coupled lithofacies clusters and construct the parameter division standard table of the geological-mechanical coupled lithofacies classification system, thereby determining the geological-mechanical coupled lithofacies classification system.

The parameter determination sub-module includes: a characteristic attribute determination unit, a distribution difference determination unit, and a parameter determination unit.

The characteristic attribute determination unit is connected to the processing sub-module, and configured to determine a characteristic attribute through single-factor cluster characteristic extraction and multi-well analogy analysis based on the arranged data.

The distribution difference determination unit is connected to the characteristic attribute determination unit, and configured to perform, based on the characteristic attribute, single-well transverse and multi-well longitudinal attribute consistency checks, respectively, and determine a distribution difference of each type of mechanics parameter on different geological lithofacies.

The parameter determination unit is connected to the distribution difference determination unit, and configured to determine the difference sensitive rock mechanics parameter based on the distribution difference.

An embodiment of the present disclosure further provides a lithofacies analysis method based on a shale geological-mechanical coupled lithofacies classification system, including the following steps.

Information data are acquired, including geological lithofacies data and in-situ mechanics parameter data.

The geological-mechanical coupled lithofacies classification system is determined based on the information data. Single-well quantitative prediction of lithofacies is performed by the geological-mechanical coupled lithofacies classification system based on logging data, so as to acquire single-well lithofacies prediction information, where the single-well lithofacies prediction information refers to a prediction result of single-well geological-mechanical coupled lithofacies in an entire wellbore space within a range of a bed of interest, and is configured to characterize a facies sequence change characteristic of the single-well geological-mechanical coupled lithofacies along a wellbore.

Feedback adjustment is performed on the single-well lithofacies prediction information based on a set range of a rock mechanics and geostress parameter, so as to acquire adjustment information.

Seismic attribute embedding and integrated inversion are performed through a genetic algorithm based on seismic attribute data and the adjustment information, and a three-dimensional model for well-seismic collaborative modeling of geological-mechanical coupled lithofacies is constructed through a collaborative Kriging method, where the three-dimensional model is a three-dimensional physical simulation model constructed based on an inherent relationship between respective properties of a geological lithofacies and the geological-mechanical coupled lithofacies, and configured to characterize a mechanical heterogeneity difference and distribution law of the geological lithofacies.

A geological-mechanical coupled lithofacies control rock mechanics and geostress parameter model is determined based on the three-dimensional model through a layer control-facies control constraint, where the parameter model is configured to characterize three-dimensional spatial distribution heterogeneity of a geological-mechanical characteristic of a shale bed, thereby providing a basis for the exploration and development of an artificial oil and gas reservoir in a production area.

Specifically, the geological-mechanical coupled lithofacies classification system is determined based on the information data as follows.

Data arrangement and singularity removal are performed based on the information data, a positional correspondence principle or similarity and contiguity principle, and a logging response characteristic, so as to acquire arranged data.

A difference sensitive rock mechanics parameter is determined based on the arranged data, where the difference sensitive rock mechanics parameter includes tensile strength, shear strength, and Young's modulus.

A geological-mechanical coupled lithofacies cluster core is determined based on the information data and the difference sensitive rock mechanics parameter.

A boundary and an intersection range of geological-mechanical coupled lithofacies clusters are determined based on the geological-mechanical coupled lithofacies cluster core and the boundary and range of the geological-mechanical coupled lithofacies clusters are determined.

A geological-mechanical coupled lithofacies classification chart is drawn based on the boundary and range of the geological-mechanical coupled lithofacies clusters, and a parameter division standard table is constructed for a lithofacies classification system, thereby determining the geological-mechanical coupled lithofacies classification system.

Specifically, the difference sensitive rock mechanics parameter is determined based on the arranged data as follows.

A characteristic attribute is determined through single-factor cluster characteristic extraction and multi-well analogy analysis based on the arranged data. Single-well transverse and multi-well longitudinal attribute consistency checks are performed respectively based on the characteristic attribute. A distribution difference of each type of mechanics parameter on different geological lithofacies are determined. A difference sensitive rock mechanics parameter is determined based on the distribution difference.

The seismic attribute embedding and the integrated inversion are performed through the genetic algorithm based on the seismic attribute data and the adjustment information, and the three-dimensional model for the well-seismic collaborative modeling of the geological-mechanical coupled lithofacies through the collaborative Kriging method. The specific process is as follows.

A genetic neural network architecture parameter is determined, including a number of iterations, a correlation threshold, weight decay, and a number of nodes in a hidden layer of a neural network. A single-well seismic attribute data embedding volume is extracted by the genetic algorithm based on the genetic neural network architecture parameter and the seismic attribute data. Seismic attribute embedding and integrated inversion are performed based on the adjustment information and the single-well seismic attribute data embedding volume to acquire an inversion data volume. Data coarsening of the single-well geological lithofacies and geological-mechanical coupled lithofacies is performed, and lithofacies data analysis is performed to acquire analyzed data. A three-dimensional model for well-seismic collaborative modeling of geological-mechanical coupled lithofacies is constructed through a collaborative Kriging method based on a common constraint control of the analyzed data and the inversion data volume.

Specifically, the geological-mechanical coupled lithofacies control rock mechanics and geostress parameter model is determined based on the three-dimensional model through the layer control-facies control constraint as follows.

A single-well rock mechanics and geostress parameter is acquired. Data coarsening of the single-well rock mechanics and geostress parameter is performed, and single-layer data analysis is performed to acquire analyzed parameter data. A geological-mechanical coupled lithofacies control rock mechanics and geostress parameter model is determined by a collaborative Kriging method based on the analyzed parameter data, a layer control-facies control constraint, the single-well rock mechanics and geostress parameter, and the three-dimensional model.

The single-well rock mechanics and geostress parameter is acquired through an experimental means, including uniaxial compression, triaxial compression, and point load strength.

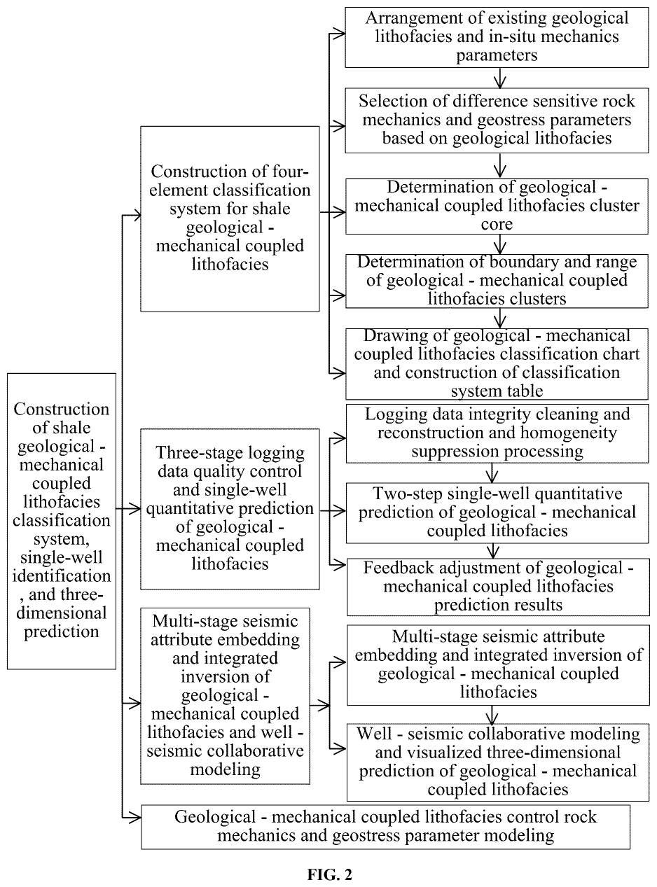

As shown in FIG. 2, the method proposed by the present disclosure, namely the method system based on the construction of the shale geological-mechanical coupled lithofacies classification system, single-well identification, and three-dimensional prediction, covers 4 key technologies and 10 key technical procedures.
1. The construction of the four-element classification system for the shale geological-mechanical coupled lithofacies involves the following aspects. (1) The classification system is constructed based on the arrangement of existing geological lithofacies and in-situ mechanics parameters and relying on the comparison of geological lithofacies with corresponding rock mechanics parameters one by one. (2) Based on the principle of optimal difference, difference sensitive rock mechanics and geostress parameters of the geological lithofacies are selected as the basis for further subdividing the geological-mechanical coupled lithofacies type. (3) Based on the selected four elements, the subdivision of the geological-mechanical coupled lithofacies is performed, and the core of each type of geological-mechanical coupled lithofacies cluster is analyzed and determined from a cross-plot of the four elements. (4) An intersection range between the cluster boundary and different geological-mechanical coupled lithofacies clusters is determined. (5) A geological-mechanical coupled lithofacies classification chart is drawn, and a parameter division standard table is constructed for the geological-mechanical coupled lithofacies classification system, thereby completing the construction of the geological-mechanical coupled lithofacies classification system.
2. Three-stage logging data quality control and single-well quantitative prediction of geological-mechanical coupled lithofacies are performed. According to the parameter division standard of the geological-mechanical coupled lithofacies classification system, three stages are divided for single-well identification and quantitative prediction of the geological-mechanical coupled lithofacies. (1) Logging data integrity cleaning and reconstruction, as well as homogeneity suppression processing, is performed. (2) single-well quantitative prediction of the lithofacies is performed. (3) Feedback adjustment of the prediction result is performed based on a logging response characteristic to ensure the accuracy and authenticity of the geological-mechanical coupled lithofacies classification.
3. Multi-stage seismic attribute embedding and integrated inversion of the geological-mechanical coupled lithofacies and well-seismic collaborative modeling are performed, including the following aspects: (1) multi-stage seismic attribute embedding and integrated inversion of the geological-mechanical coupled lithofacies; and (2) well-seismic collaborative modeling and visualized three-dimensional prediction.
4. Rock mechanics and geostress parameter modeling based on geological-mechanical coupled lithofacies control

The specific steps are as follows.

### 1) Construction of Four-Element Classification System for Shale Geological-Mechanical Coupled Lithofacies

### A. Existing Geological Lithofacies and In-Situ Mechanics Parameters are Arranged.

The geological lithofacies of marine or terrestrial shale is acquired based on Chinese patent application 202011398837.8 “Method for Classification, Identification, and Three-dimensional Characterization of Marine Shale Lithofacies” and Chinese patent application 202011393013.1 “Intelligent Identification and Visualization Method for Lithofacies of Terrestrial Tight Reservoir”. The in-situ mechanics parameters are acquired based on Chinese patent application 202011388424.1 “Three-dimensional Visualization Characterization Method for Geostress of Tight Rock Mass”.

After the geological lithofacies of the marine or terrestrial shale is acquired, based on the arranged in-situ mechanics parameters, the mechanics parameter data corresponding to the geological lithofacies is extracted along a wellbore, with the wellbore as the core. Based on the positional correspondence principle, existing geological lithofacies data are properly arranged and merged according to the logging response characteristic. Alternatively, based on the similarity and contiguity principle, a geological lithofacies with a small quantity and a small distribution thickness is merged into an adjacent dominant geological lithofacies, and the overall geological lithofacies classification system of the region is determined based on the principle of appropriate connectivity and a large number of data samples.

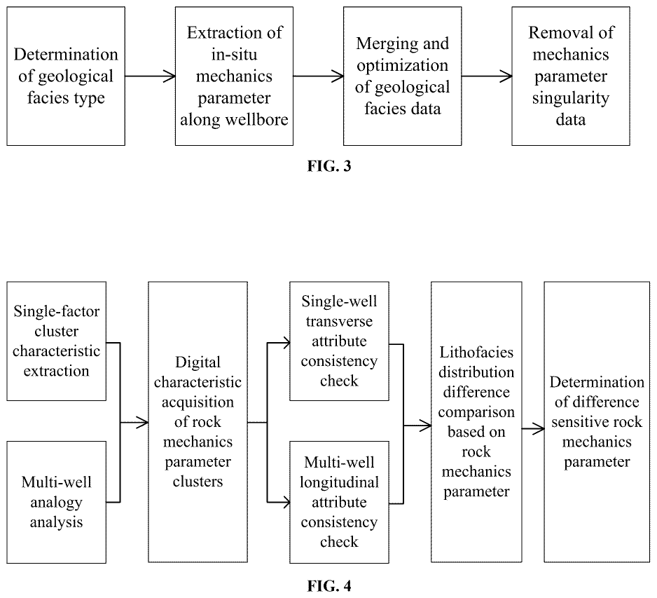

Based on the logging response and the determined geological lithofacies data, the acquired in-situ mechanics parameters are compared and arranged. Singularities are eliminated, an in-situ mechanics parameter dataset is determined, and the statistical characteristics of the dataset are extracted. FIG. 3 shows the step-by-step process of acquiring the geological lithofacies and arranging the in-situ mechanics parameters.

### B. Difference Sensitive Rock Mechanics and Geostress Parameters of the Geological Lithofacies are Selected.

After the geological lithofacies type and the in-situ mechanics parameter dataset are determined, the difference sensitive rock mechanics and geostress parameters of the geological lithofacies are further analyzed, compared, and selected. Firstly, single-factor cluster characteristic extraction and multi-well analogy analysis are performed to acquire digital characteristic attributes of different rock mechanics and geostress parameter clusters in each type of geological facies. On this basis, the consistency of single-well longitudinal and multi-well transverse attributive characteristics is determined. Based on the verified consistency of the same type of geological lithofacies on different mechanics parameters in a single and multiple wells, the distribution differences of each type of mechanics parameter on different types of geological lithofacies are determined. Finally, the distribution differences of the digital characteristics of each type of rock mechanics and geostress parameter on different types of geological lithofacies are compared, and parameters with the greatest distribution difference are selected as the difference sensitive rock mechanics and geostress parameters. By using the above method to perform practical screening operations, the difference sensitive parameters are determined as tensile strength, shear strength, and Young's modulus.

After literature and on-site investigations are performed to find that there is a significant correlation between the creation of fractures in shale fracturing processes and tensile strength. The shear strength of the rock mass has a significant impact on the operational efficiency of drilling processes, and the Young's modulus not only plays a decisive role in evaluating the deformation resistance of the rock mass, but also has a certain linear relationship with shale brittleness. The above three types of parameters can be used to characterize the strength, elasticity, and brittleness of shale, and are consistent with the parameter types determined through difference sensitive parameter selection. Therefore, they can serve as reliable data for subsequent research. FIG. 4 shows the technical flowchart for parameter selection.

### C. The Core of the Geological-Mechanical Coupled Lithofacies Cluster is Determined.

Based on the determined difference sensitive in-situ mechanics parameters of the geological lithofacies, combined with the geological lithofacies, geological-mechanical coupled lithofacies classification and identification is performed. That is, with the geological lithofacies as the core and mechanics parameters as classification parameters, the geological lithofacies are classified in multiple directions and dimensions to determine multiple geological-mechanical coupled lithofacies clusters within the same geological lithofacies. Based on the differences in geological and mechanical properties, one or more representative points of the same cluster are identified to determine the core of the geological-mechanical coupled lithofacies cluster.

### D. The Boundary and Range of the Geological-Mechanical Coupled Lithofacies Clusters are Determined.

Based on the core of the geological-mechanical coupled lithofacies cluster, the boundary and intersection range of the geological-mechanical coupled lithofacies clusters is further analyzed. The boundary of the lithofacies cluster can be defined by analyzing the mechanical characteristics change of the geological-mechanical coupled lithofacies. Alternatively, some logging curves are selected, a change threshold is set, and the boundary is set in an area with a significant change in the characteristic of the geological-mechanical coupled lithofacies. After the initial determination of the cluster boundary, the range of the intersection between different lithofacies clusters is acquired based on the response range of the mechanical curve. The position of the boundary zone is adjusted according to the principle of maximizing the range of each lithofacies cluster and minimizing the intersection range between different lithofacies. After the optimization of the cluster boundary and intersection range is completed, the reliability of the cluster core is validated reversely and adjusted appropriately based on the validation result, thereby ensuring the overall reliability of the cluster core, the boundary, and the intersection range.

### E. A Geological-Mechanical Coupled Lithofacies Classification Chart is Drawn, and a Classification System Table is Constructed.

Based on the above analysis results, draw the geological-mechanical coupled lithofacies classification chart is drawn, and a parameter division standard table of the lithofacies classification system is constructed, thereby completing the construction of the geological-mechanical coupled lithofacies classification system. According to the above process, accurate classification and identification of the shale geological-mechanical coupled lithofacies is achieved.

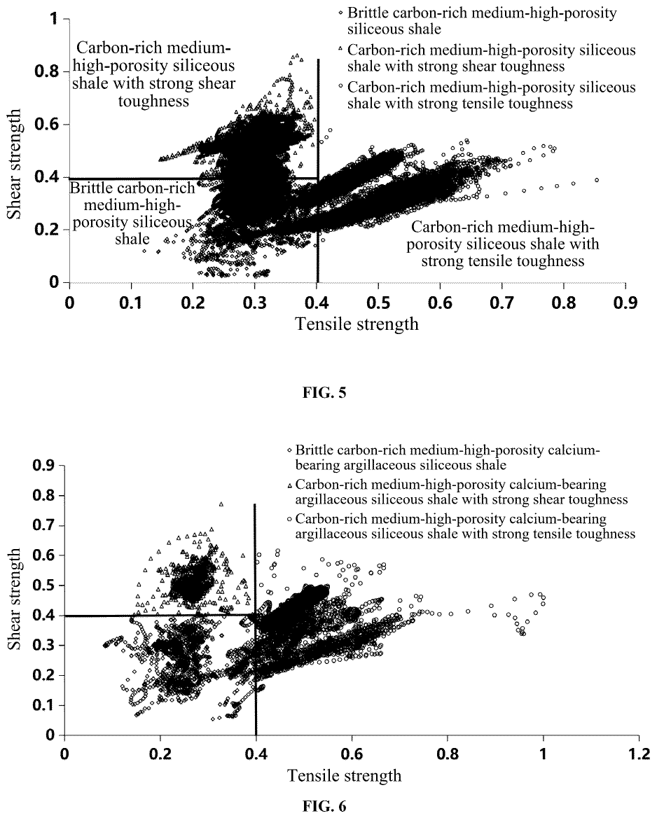

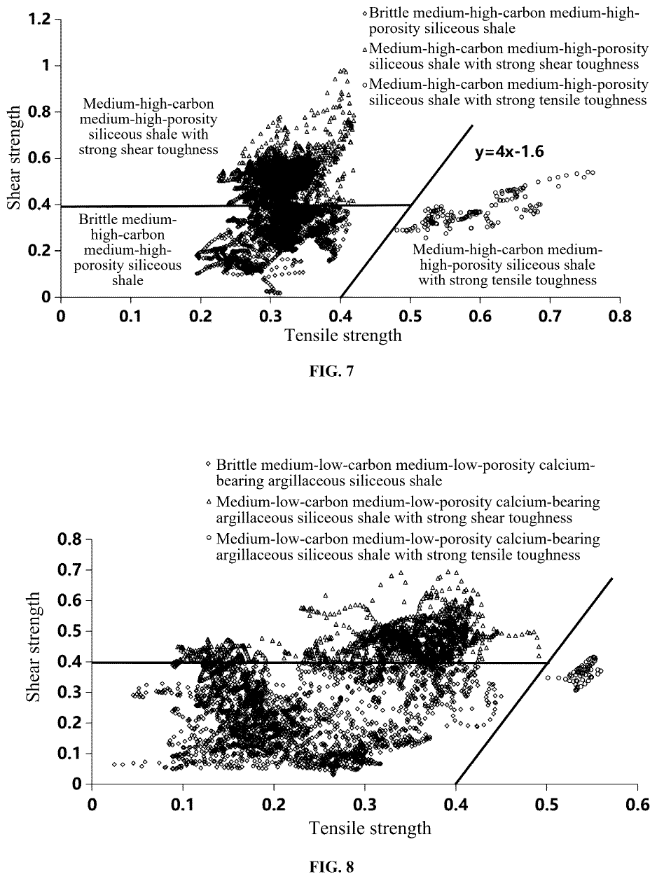

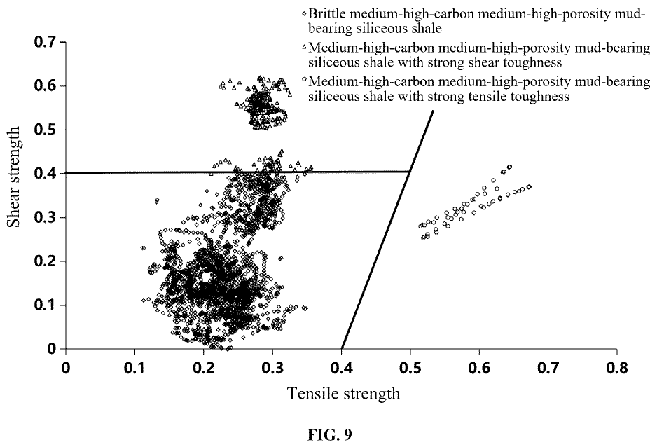

FIGS. 5 to 9 show a classification chart of the geological-mechanical coupled lithofacies of a main production horizon in a marine shale production area. It can be seen that for the 5 types of geological lithofacies in the study area, further triple classification: brittleness, strong shear toughness, and strong tensile toughness is achieved based on mechanical characteristics, and 15 types of geological-mechanical coupled lithofacies are constructed on the basis of geological lithofacies. The cluster cores of different geological-mechanical coupled lithofacies maintain independence, and the distribution of different cluster boundaries and intersection ranges is obvious. From this, it can be seen that the geological-mechanical coupled lithofacies classification system of the shale bed in this area constructed based on the above method can be well applied to on-site production research, providing good guidance for understanding the geological-mechanical coupled characteristics on site.

Based on the classification chart, a classification system table for different geological-mechanical coupled lithofacies is constructed. Table 1 shows the classification system of the 5 types of geological lithofacies and 15 types of geological-mechanical coupled lithofacies shown in FIGS. 5 to 9, as well as the corresponding classification parameter standards for each type of geological-mechanical coupled lithofacies. It can be seen that different types of geological lithofacies are classified into different types of geological-mechanical coupled lithofacies according to corresponding standards. The mechanics parameter characteristics of each type of lithofacies vary greatly, and the division standard of the mechanics parameters include but are not limited to constants and functions, depending on the geological or mechanical characteristics of the core of each type of lithofacies.

TABLE 1
Table of geological - mechanical coupled lithofacies classification system and
corresponding type classification parameter standards for a shale bed

| | | | | Range of |
|---|---|---|---|---|
| Type and name of | Type and name of geological - | | | Young’s |
| geological lithofacies | mechanical coupled lithofacies | Range of tensile strength | Range of shear strength | modulus |
| Carbon-rich | Brittle carbon-rich | 0-0.4 | 0-0.4 | 0.06-0.67 |
| medium-high-porosity | medium-high-porosity siliceous shale | | | |
| siliceous shale | Carbon-rich medium-high-porosity | 0-0.4 | >0.4 | 0.02-0.86 |
| | siliceous shale with strong shear | | | |
| | toughness | | | |
| | Carbon-rich medium-high-porosity | >0.4 | 0.04-0.91 | 0.16-0.72 |
| | siliceous shale with strong tensile | | | |
| | toughness | | | |
| Carbon-rich | Brittle carbon-rich | 0-0.4 | 0-0.4 | 0.23-0.94 |
| medium-high-porosity | medium-high-porosity calcium-bearing | | | |
| calcium-bearing | mud-bearing siliceous shale | | | |
| mud-bearing siliceous | Carbon-rich medium-high-porosity | 0-0.4 | >0.4 | 0.19-0.92 |
| shale | calcium-bearing mud-bearing siliceous | | | |
| | shale with strong shear toughness | | | |
| | Carbon-rich medium-high-porosity | >0.4 | 0.15-1 | 0.53-0.94 |
| | calcium-bearing mud-bearing siliceous | | | |
| | shale with strong tensile toughness | | | |
| Medium-high-carbon medium-high-porosity | Brittle medium-high-carbon medium-high-porosity siliceous shale | $\{ \begin{matrix}0 - 0.4 \\ 0.4 - 0.25 * {X}_{shear}^{′} + 0.4\end{matrix}$ | 0-0.4 | 0.2-0.8 |
| siliceous shale | Medium-high-carbon medium-high-porosity siliceous shale | $\{ \begin{matrix}0 - 0.4 \\ 0.4 - 0.25 * {X}_{shear}^{′} + 0.4\end{matrix}$ | >0.4 | 0.2-1 |
| | with strong shear toughness | | | |
| | Medium-high-carbon medium-high-porosity siliceous shale with strong tensile toughness | >0.5 | $\{ \begin{matrix}0 - 0.4 \\ 0.4 - 4 * {X}_{tensile}^{′} - 1.6\end{matrix}$ | 0.7-1 |
| Medium-low-carbon medium-low-porosity | Brittle medium-low-carbon medium-low-porosity calcium-bearing | $\{ \begin{matrix}0 - 0.4 \\ 0.4 - 0.25 * {X}_{shear}^{′} + 0.4\end{matrix}$ | 0-0.4 | 0.1-0.8 |
| calcium-bearing | argillaceous siliceous shale | | | |
| siliceous | | | | |
| argillaceous siliceous shale | Medium-low-carbon medium-low-porosity calcium-bearing | $\{ \begin{matrix}0 - 0.4 \\ 0.4 - 0.25 * {X}_{shear}^{′} + 0.4\end{matrix}$ | >0.4 | 0.1-1 |
| | argillaceous siliceous shale with strong | | | |
| | shear toughness | | | |
| | Medium-low-carbon medium-low-porosity calcium-bearing | >0.5 | $\{ \begin{matrix}0 - 0.4 \\ 0.4 - 4 * {X}_{tensile}^{′} - 1.6\end{matrix}$ | 0.4-0.8 |
| | argillaceous siliceous shale with strong | | | |
| | tensile toughness | | | |
| Medium-high-carbon medium-high-porosity | Brittle medium-high-carbon medium-high-porosity mud-bearing | $\{ \begin{matrix}0 - 0.4 \\ 0.4 - 0.25 * {X}_{shear}^{′} + 0.4\end{matrix}$ | 0-0.4 | 0-0.6 |
| mud-bearing siliceous | siliceous shale | | | |
| shale | Medium-high-carbon medium-high-porosity mud-bearing | $\{ \begin{matrix}0 - 0.4 \\ 0.4 - 0.25 * {X}_{shear}^{′} + 0.4\end{matrix}$ | >0.4 | 0.6-0.9 |
| | siliceous shale with strong shear | | | |
| | toughness | | | |
| | Medium-high-carbon medium-high-porosity mud-bearing | >0.5 | $\{ \begin{matrix}0 - 0.4 \\ 0.4 - 4 * {X}_{tensile}^{′} - 1.6\end{matrix}$ | 0.8-0.9 |
| | siliceous shale with strong tensile | | | |
| | toughness | | | |

In Table 1, X′ₛₕₑₐᵣ denotes a shear strength value; and X′ₜₑₙₛᵢₗₑ denotes a tensile strength value.

### (2) Three-Stage Logging Data Quality Control and Single-Well Quantitative Prediction of Geological-Mechanical Coupled Lithofacies

On the basis of the shale geological-mechanical coupled lithofacies classification system, quantitative prediction of single-well lithofacies is further performed, laying a good data foundation for the three-dimensional modeling of the geological-mechanical coupled lithofacies.

### A. In a First Stage, Logging Data Integrity Cleaning and Reconstruction, as Well as Homogeneity Suppression Processing, is Performed.

Logging data integrity cleaning and reconstruction, as well as homogeneity suppression processing, is performed to provide reliable data sources for the calculation of the mechanics parameters. (1) Data integrity cleaning and reconstruction are very important steps in data processing, aimed at ensuring the quality and reliability of data. This stage mainly checks whether there are missing or abnormal values in the logging data, and performs secondary processing of the logging data through filling, deletion, or interpolation to ensure the reliability and authenticity of the logging data. (2) The data homogeneity suppression processing mainly targets the impact of similar data in the analysis and modeling process, with the goal of reducing duplication or redundancy in the logging dataset, thereby ensuring the accuracy of the mechanics parameters constructed based on the original logging data, as well as the geological-mechanical coupled lithofacies classification results.

### B. In a Second Stage, the Single-Well Quantitative Prediction of the Geological-Mechanical Coupled Lithofacies is Performed Through a Two-Step Method.

The single-well quantitative prediction of the geological-mechanical coupled lithofacies is performed through two steps.

In a first step, the geological lithofacies of marine or terrestrial shale is acquired through division and identification based on Chinese patent application ZL202011398837.8 “Method for Classification, Identification, and Three-dimensional Characterization of Marine Shale Lithofacies” and Chinese patent application ZL202011393013.1 “Intelligent Identification and Visualization Method for Lithofacies of Terrestrial Tight Reservoir”. Based on Chinese patent application ZL202011388424.1 “Three-dimensional Visualization Characterization Method for Geostress of Tight Rock Mass”, a single-well difference sensitive mechanics parameter curve is acquired. In this way, the preparation of geological lithofacies, rock mechanics, and geostress data for the single-well prediction of geological-mechanical coupled lithofacies is completed.

In a second step, based on the acquired parameter division standard of the geological-mechanical coupled lithofacies system and different types of geological lithofacies, the single-well subdivided prediction of the geological-mechanical coupled lithofacies is completed through the single-well differential sensitivity mechanics parameter curve.

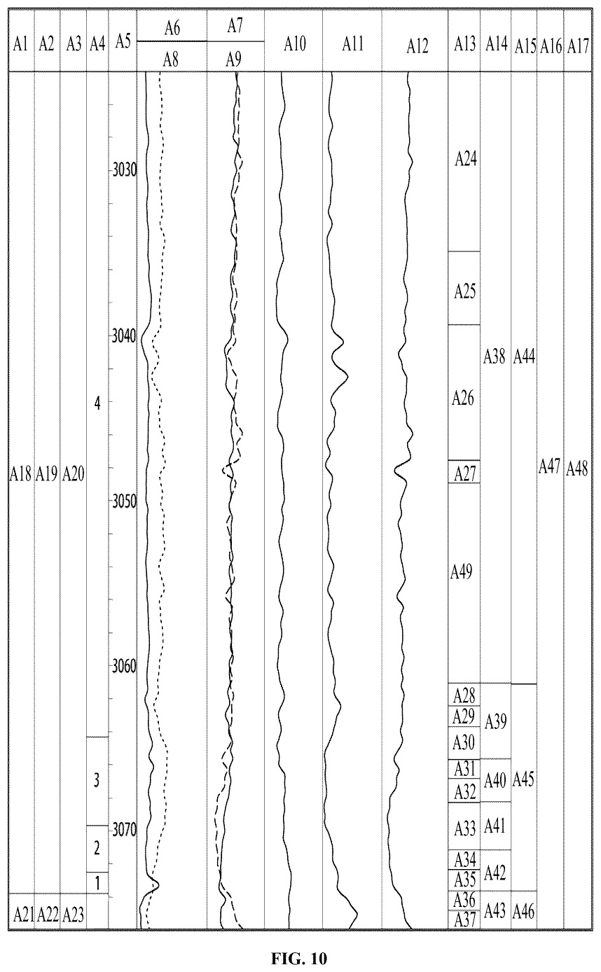

In the actual case area, firstly, the selected single-well difference sensitive mechanics parameter curves of shale, including tensile strength, shear strength, and Young's modulus, are calculated. Then, based on the original 5 types of geological lithofacies, the prediction of the geological-mechanical coupled lithofacies of the entire wellbore space within the range of the bed of interest is further performed according to the classification parameter standards corresponding to each type of geological-mechanical coupled lithofacies. Finally, a comprehensive column chart of single-well geological-mechanical coupled lithofacies is drawn (FIG. 10), showing the facies sequence change characteristics of typical single-well geological-mechanical coupled lithofacies along the wellbore in the actual case area.

### C. In a Third Stage, Feedback Adjustment is Performed on the Prediction Result of the Geological-Mechanical Coupled Lithofacies.

Based on the prediction result of the single-well geological-mechanical coupled lithofacies, according to the principles of reasonable classification, sufficient data volume, and reasonable and uniform arrangement of adjacent classes, combined with the range of the rock mechanics and geostress parameters of the geological-mechanical coupled lithofacies proposed in the present disclosure, the prediction result is subjected to feedback adjustment so as to make it more reasonable and reliable, meeting geological laws. The design provides reliable data support for subsequent three-dimensional prediction and modeling of geological-mechanical coupled lithofacies.

### (3) Multi-Stage Seismic Attribute Embedding and Integrated Inversion of Geological-Mechanical Coupled Lithofacies and Well-Seismic Collaborative Modeling

Based on the seismic attribute extraction and selection method provided by Chinese patent application 202011393012.7 “Three-dimensional In-situ Characterization Method for Generation and Accumulation Performance Heterogeneity of Shale”, work A is performed. That is, multi-stage seismic attribute embedding and integrated inversion of the geological-mechanical coupled lithofacies is performed to acquire an inversion data volume for the geological-mechanical coupled lithofacies. Based on the achievement data acquired from the above technology process, work B is further performed through the well-seismic collaborative modeling and characterization method provided by Chinese patent application 202011393012.7 “Three-dimensional In-situ Characterization Method for Generation and Accumulation Performance Heterogeneity of Shale”. That is, well-seismic collaborative modeling and visualized three-dimensional prediction of the geological-mechanical coupled lithofacies is performed to acquire a three-dimensional model of the geological-mechanical coupled lithofacies, thereby completing three-dimensional attribute and distribution prediction for the geological-mechanical coupled lithofacies.

### A. Multi-Stage Seismic Attribute Embedding and Integrated Inversion of Geological-Mechanical Coupled Lithofacies

The “multi-stage” mentioned in this method mainly includes the following parts. (1) The preliminary extracted seismic attributes are selected and determined, laying the data foundation for subsequent attribute extraction and inversion. (2) Based on the extracted seismic attributes, the “multi-level extraction” of the attributes is continuously performed, and a single-well seismic attribute data embedding volume is extracted through the genetic algorithm. (3) Based on a learning correlation coefficient presented after attribute extraction, the quality of the extraction effect is determined, the variable parameter in the genetic neural network architecture is adjusted appropriately before attribute extraction is performed again, a genetic neural network structure with the highest learning correlation coefficient is selected, and a three-dimensional inversion data volume is generated based on the genetic neural network structure as the final input data participating in well-seismic collaborative modeling. The “integration” in integrated inversion is manifested as the reciprocation and continuous optimization of attribute extraction embedding and genetic network structure parameter adjustment. Specifically, the acquired single-well geological-mechanical coupled lithofacies along the wellbore space is taken as the target. Relying on multi-stage seismic attribute embedding, the seismic attribute data volume consistent with the statistical characteristics of the geological-mechanical coupled lithofacies in the wellbore space is extracted, providing reliable basic data for three-dimensional modeling representation.

In an actual case, the specific operational steps are as follows. (1) Single-well relative acoustic impedance attributes are extracted, providing a data foundation for subsequent multi-stage extraction embedding of other attributes and integrated inversion (note: in this case, after actual embedding of seismic attributes, the learning correlation coefficient is the highest if only the relative acoustic impedance attributes are extracted for inversion). (2) After the relative acoustic impedance extraction, the corresponding seismic data volume and single-well lithofacies are used as input data, and the vertical range, as well as the seismic sub-value variables such as inline and cross-line half-range, and seismic resampling parameter are adjusted. (3) The genetic neural network architecture parameter is set, including the number of iterations, correlation thresholds, weight decay, and the number of hidden layer nodes in the neural network. On this basis, the single-well seismic attribute data volume is extracted through the genetic algorithm. (4) Based on the numerical value of the learning correlation coefficient, the extraction effect is evaluated. By adjusting the seismic data volume parameters and learning parameters of the genetic neural network, attribute extraction is repeatedly performed to acquire the single-well lithofacies seismic attribute data volume with the best extraction effect. (5) After the extraction of the single-well attributes is completed, integrated inversion is performed to acquire the three-dimensional seismic inversion volume of the area where the single well is located, providing reliable data for subsequent well-seismic collaborative modeling. The analysis process of the geological-mechanical coupled lithofacies involves the geological and mechanical characteristics of the lithofacies and their correlation, single-well seismic attribute data volume extraction is also performed for geological lithofacies in practical operations.

Table 2 shows the settings of various parameters for extracting attributes of the geological-mechanical coupled lithofacies through the genetic algorithm. It can be seen that the learning correlation coefficient is the highest, namely 0.9005, under the following conditions: the vertical range is 50; the inline, cross-line half-range, and resampling parameter each are 3; the number of iterations is 20,000; the correlation threshold is 0.001; and the number of hidden layer nodes in the neural network is 4.

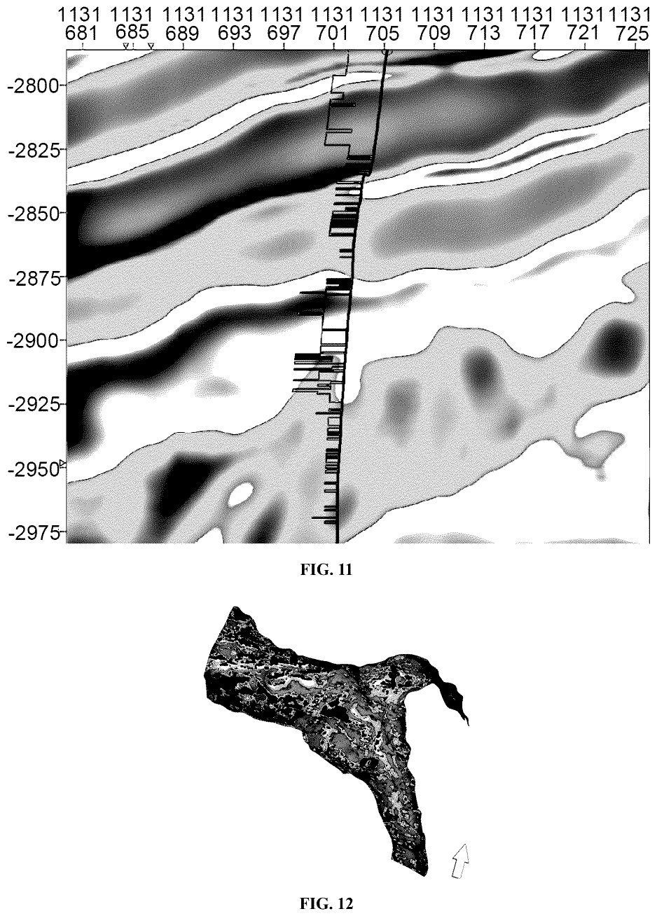

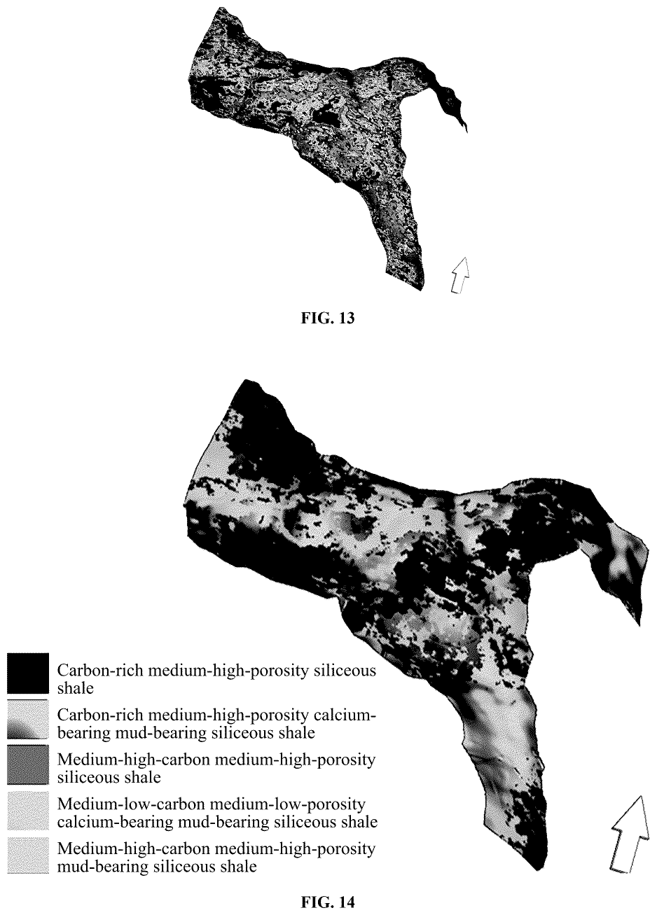

FIG. 11 shows the inversion profile of a single-well lithofacies generated after attribute extraction. It can be seen that there is a good correlation between the single-well lithofacies and the seismic profile. FIGS. 12 and 13 show the three-dimensional inversion data volumes of the geological lithofacies and the geological-mechanical coupled lithofacies after attribute extraction and integrated inversion. It can be seen that there is a certain correlation between the geological lithofacies and the geological-mechanical coupled lithofacies in terms of distribution, and the latter is more complex than the former.

TABLE 2
Statistical table of parameter settings for multi-stage seismic attribute
embedding and integrated Inversion of geological - mechanical coupled lithofacies

| Name | SN | | | | | |
|---|---|---|---|---|---|---|
| of variable | 1 | 2 | 3 | 4 | 5 | 6 |
| Vertical range | 50 | 40 | 60 | 70 | 50 | 50 |
| Inline half-range | 1 | 1 | 1 | 1 | 2 | 3 |
| Cross-line | 1 | 1 | 1 | 1 | 2 | 3 |
| half-range | | | | | | |
| Resampling | 3 | 3 | 3 | 3 | 3 | 3 |
| parameter | | | | | | |
| Number of | 20000 | 20000 | 20000 | 20000 | 20000 | 20000 |
| iterations | | | | | | |
| Correlation | 0.9 | 0.9 | 0.9 | 0.9 | 0.9 | 0.9 |
| threshold | | | | | | |
| Weight decay | 0.001 | 0.001 | 0.001 | 0.001 | 0.001 | 0.001 |
| Number of | 3 | 4 | 4 | 4 | 3 | 4 |
| hidden layer | | | | | | |
| nodes | | | | | | |
| Learning | 0.8632 | 0.8511 | 0.8817 | 0.8755 | 0.8920 | 0.9005 |
| correlation | | | | | | |
| coefficient | | | | | | |

### B. Well-Seismic Collaborative Modeling and Visualized Three-Dimensional Prediction of Geological-Mechanical Coupled Lithofacies

On the basis of multi-stage seismic attribute embedding and integrated inversion, well-seismic collaborative modeling is further performed for single-well lithofacies to achieve the goal of predicting the three-dimensional spatial distribution of the lithofacies. The specific steps are as follows. (1) Data coarsening of single-well geological lithofacies and geological-mechanical coupled lithofacies is performed, and single-layer lithofacies data analysis is performed layer by layer. (2) Based on the single-well lithofacies data and A: under the common constraint control of the inversion data volumes formed by multi-stage nesting inversions of seismic attributes of the geological-mechanical coupled lithofacies, a three-dimensional model of the geological lithofacies and geological-mechanical coupled lithofacies is constructed through the collaborative Kriging method.

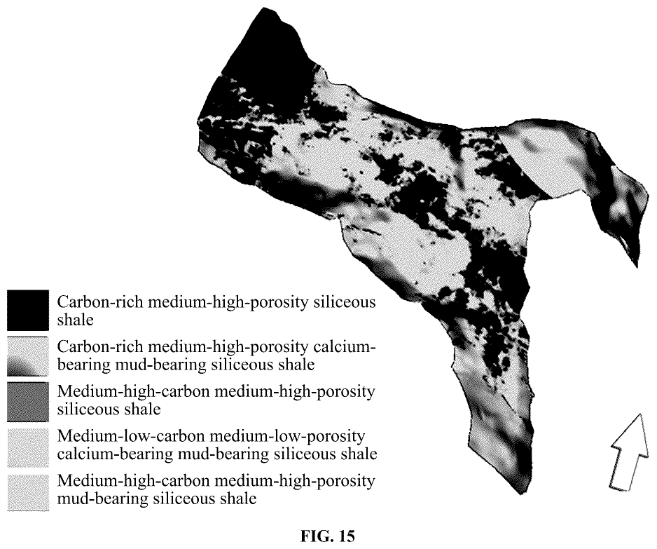

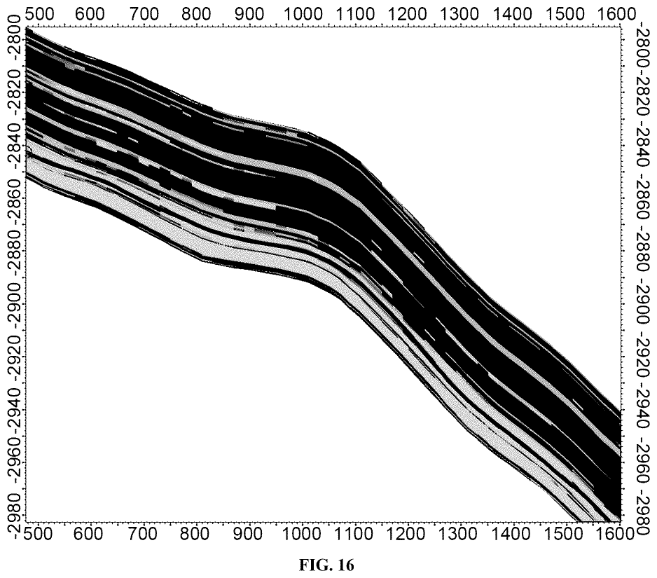

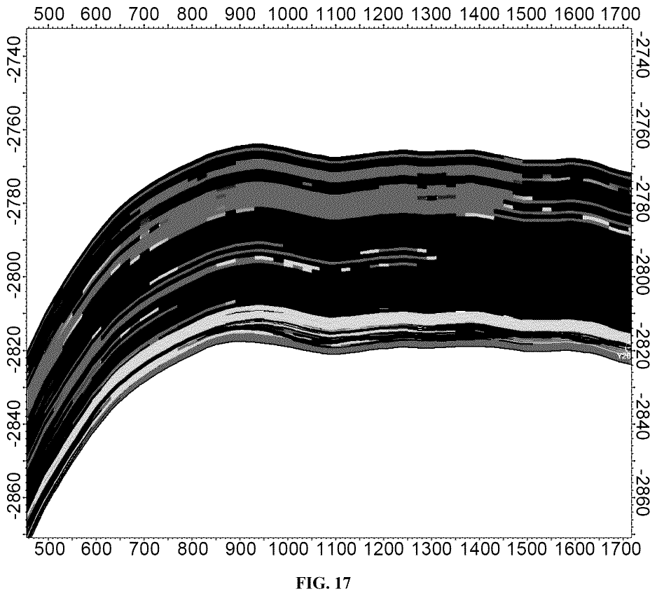

FIGS. 14 to 17 show a three-dimensional model of a shale production area with five geological lithofacies in a certain horizon, as well as a single-well lithofacies profile. It can be seen that the geological lithofacies are scattered and mixed transversely, but evenly distributed longitudinally, with obvious differentiation of the lithofacies types. The geological lithofacies shown in the figure mainly include: carbon-rich medium-high-porosity siliceous shale, carbon-rich medium-high-porosity calcium-bearing mud-bearing siliceous shale, medium-high-carbon medium-high-porosity siliceous shale, medium-low-carbon medium-low-porosity calcium-bearing argillaceous siliceous shale, and medium-high-carbon medium-high-porosity mud-bearing siliceous shale.

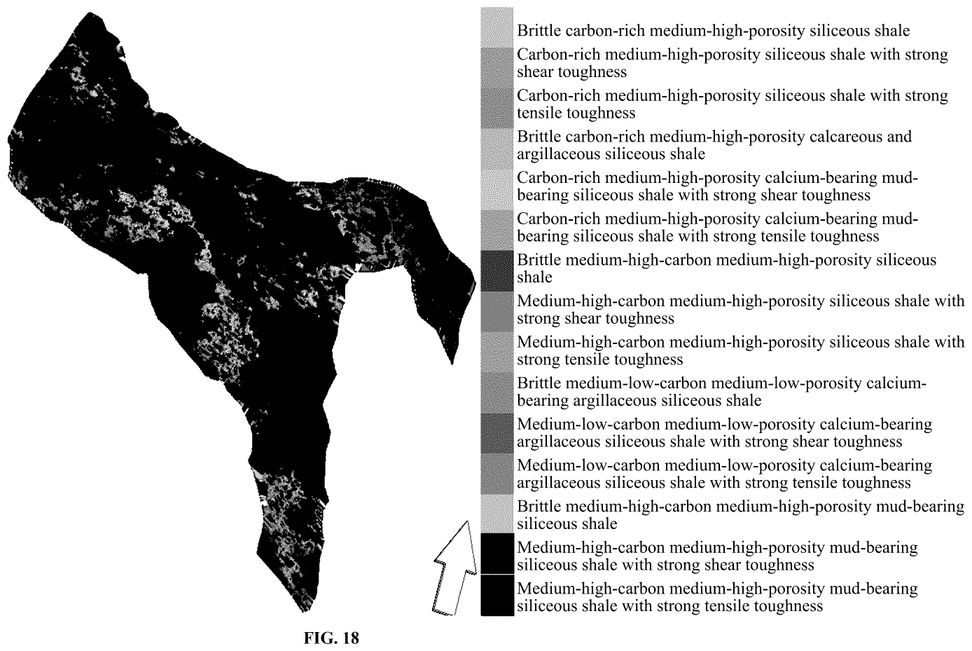

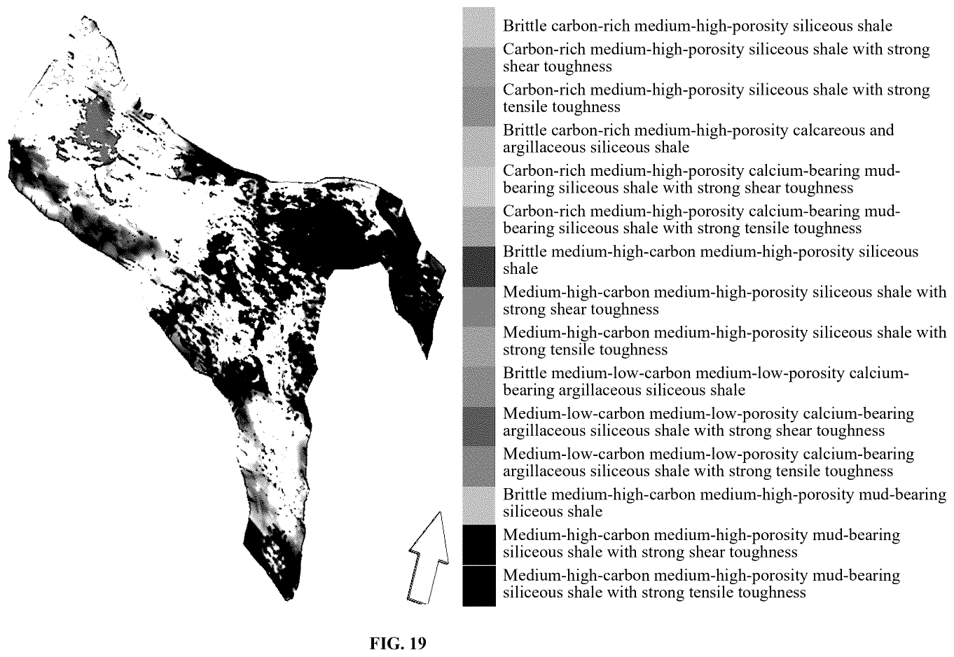

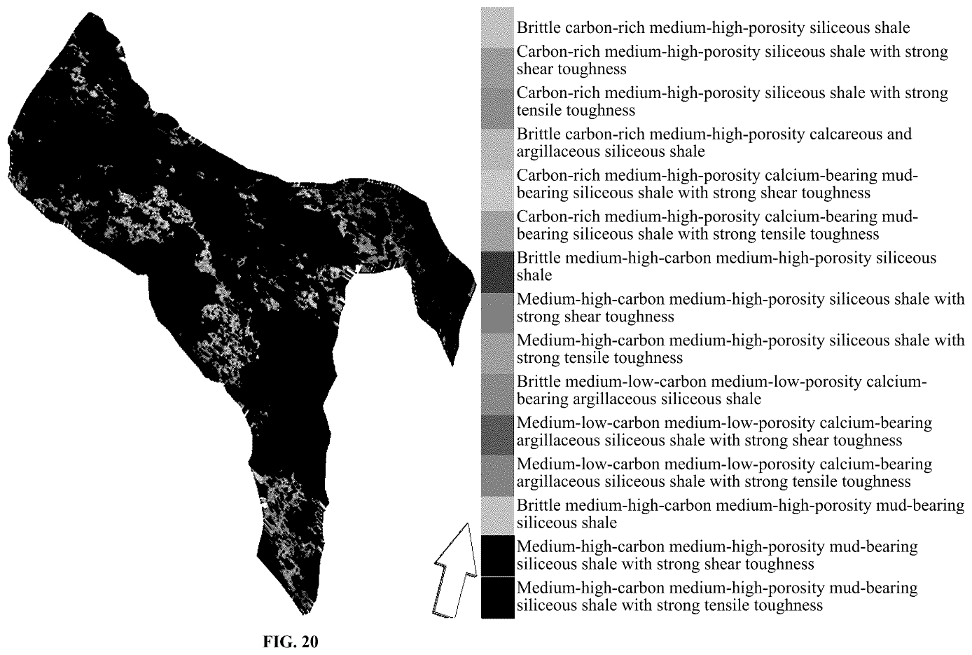

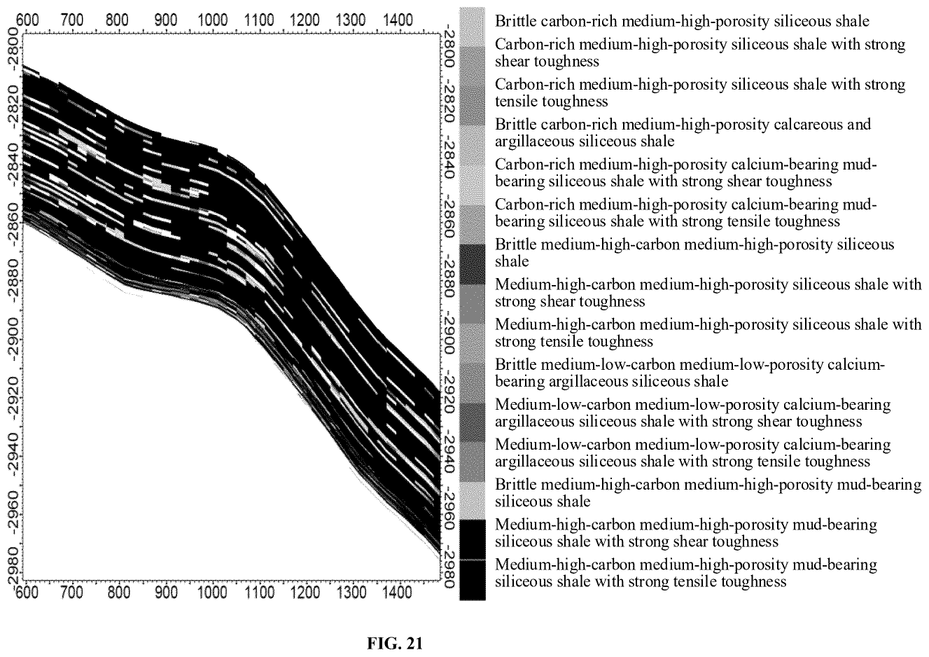

FIGS. 18 to 21 show the three-dimensional model and single-well lithofacies profile of the geological-mechanical coupled lithofacies in the corresponding horizon in the shale production area. It can be seen that compared to the geological lithofacies, the geological-mechanical coupled lithofacies are more dispersed and complex transversely, and have stronger heterogeneity in the longitudinal distribution, reflecting the mechanical heterogeneity differences of the same type of geological lithofacies.

After the geological lithofacies and the geological-mechanical coupled lithofacies are constructed, proportion statistics of the same type of geological lithofacies but different geological-mechanical coupled lithofacies is acquired. Table 3 shows proportions of the geological-mechanical coupled lithofacies for each of the 5 types of geological lithofacies. Regarding the carbon-rich medium-high-porosity siliceous shale, the brittle carbon-rich medium-high-porosity siliceous shale has the highest proportion due to its high organic carbon content. The carbon-rich medium-high-porosity calcium-bearing mud-bearing siliceous shale and the medium-low-carbon medium-low-porosity calcium-bearing argillaceous siliceous shale with high calcium and mud content include more geological-mechanical coupled lithofacies with strong shear toughness and strong tensile toughness. The statistical results in Table 3 fully demonstrate the inherent relationship between the properties of the geological lithofacies and the geological-mechanical coupled lithofacies, confirming the feasibility of the construction of the geological-mechanical coupled lithofacies classification system, single-well identification, and three-dimensional prediction.

TABLE 3
Statistical table of proportions of geological - mechanical coupled lithofacies

| | | Proportion of |
|---|---|---|
| Type and name of | Type of geological - mechanical coupled | geological - mechanical |
| geological lithofacies | lithofacies | coupled lithofacies |
| Carbon-rich | Brittle carbon-rich medium-high-porosity | 74.6% |
| medium-high-porosity | siliceous shale | |
| siliceous shale | Carbon-rich medium-high-porosity | 8.8% |
| | siliceous shale with strong shear toughness | |
| | Carbon-rich medium-high-porosity | 16.6% |
| | siliceous shale with strong tensile toughness | |
| Carbon-rich | Brittle carbon-rich medium-high-porosity | 41.9% |
| medium-high-porosity | calcium-bearing mud-bearing siliceous | |
| calcium-bearing | shale | |
| mud-bearing siliceous | Carbon-rich medium-high-porosity | 18.6% |
| shale | calcium-bearing mud-bearing siliceous | |
| | shale with strong shear toughness | |
| | Carbon-rich medium-high-porosity | 39.5% |
| | calcium-bearing mud-bearing siliceous | |
| | shale with strong tensile toughness | |
| Medium-high-carbon | Brittle medium-high-carbon | 39% |
| medium-high-porosity | medium-high-porosity siliceous shale | |
| siliceous shale | Medium-high-carbon medium-high-porosity | 14.3% |
| | siliceous shale with strong shear toughness | |
| | Medium-high-carbon medium-high-porosity | 46.7% |
| | siliceous shale with strong tensile toughness | |
| Medium-low-carbon | Brittle medium-low-carbon | 14.4% |
| medium-low-porosity | medium-low-porosity calcium-bearing | |
| calcium-bearing | argillaceous siliceous shale | |
| argillaceous siliceous | Medium-low-carbon medium-low-porosity | 7.1% |
| shale | calcium-bearing argillaceous siliceous shale | |
| | with strong shear toughness | |
| | Medium-low-carbon medium-low-porosity | 78.5% |
| | calcium-bearing argillaceous siliceous shale | |
| | with strong tensile toughness | |
| Medium-high-carbon | Brittle medium-high-carbon | 37.6% |
| medium-high-porosity | medium-high-porosity mud-bearing | |
| mud-bearing siliceous | siliceous shale | |
| shale | Medium-high-carbon medium-high-porosity | 20.1% |
| | mud-bearing siliceous shale with strong | |
| | shear toughness | |
| | Medium-high-carbon medium-high-porosity | 42.3% |
| | mud-bearing siliceous shale with strong | |
| | tensile toughness | |

### (4) Rock Mechanics and Geostress Parameter Modeling Based on Geological-Mechanical Coupled Lithofacies Control

After the construction of the shale geological-mechanical coupled lithofacies classification system, single-well identification, and three-dimensional prediction are performed to acquire the three-dimensional model of the geological-mechanical coupled lithofacies, the geological-mechanical coupled lithofacies is used as a “facies control” factor, and the fine single-layer structure and structural model are used as a “layer control” factor. The “layer control-facies control” constraint method is used to construct a three-dimensional model of the rock mechanics and geostress parameters. The specific implementation steps are as follows. (1) Single-well rock mechanics and geostress parameters are acquired. The single-well rock mechanics and geostress parameters can be acquired through experimental means such as uniaxial compression, triaxial compression, and point load strength. Alternatively, dynamic three-dimensional rock mechanics parameters can be calculated using conventional logging data, thereby acquiring static parameter values. In the present disclosure, the rock mechanics and geostress parameters are acquired using a method of calculation based on conventional well logging data. (2) Data coarsening of single-well rock mechanics and geostress parameters, as well as single-layer data analysis, is performed. (3) The geological-mechanical coupled lithofacies serves as the “facies control” factor, and the fine single-layer structure serves as the “layer control” factor, forming the “layer control-facies control” constraint. Combining the single-well rock mechanics and geostress parameters, a three-dimensional model of mechanics parameters is constructed through the collaborative Kriging method.

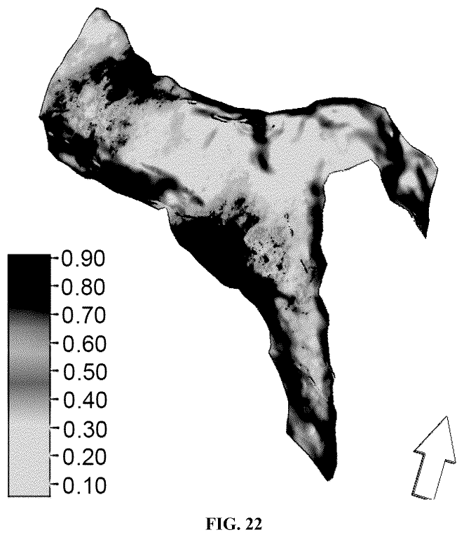

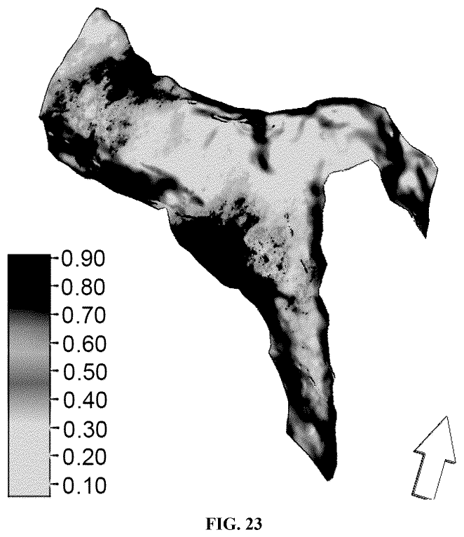

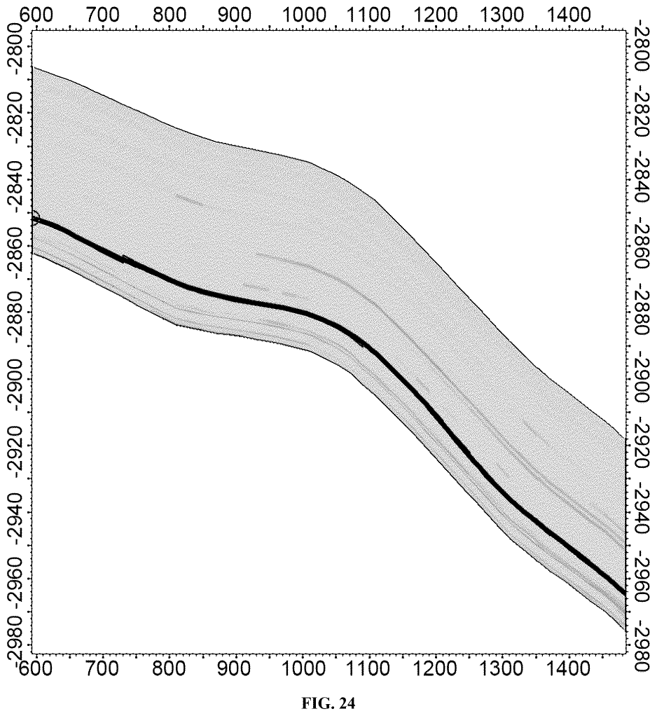

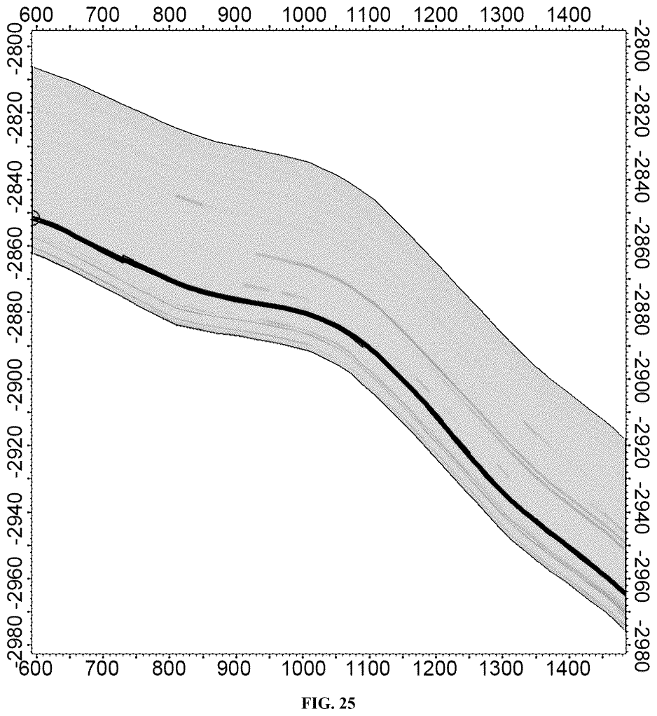

Table 4 shows the range and average values of Young's modulus parameters for random interpolation modeling and geological-mechanical coupled lithofacies control modeling. It can be seen that due to the lack of the geological-mechanical coupled lithofacies constraint, the range of mechanics parameter values for random interpolation modeling is larger than that for facies control modeling, and there is a certain deviation from the true values. FIGS. 22 to 25 respectively show the three-dimensional model and profile of the Young's modulus parameters constructed by random interpolation modeling and geological-mechanical coupled lithofacies control modeling. It can be seen that the model constructed by random interpolation is too homogeneous to characterize the complex heterogeneity of the formation. The model constructed by facies control can clearly characterize the strong heterogeneity of the formation in longitudinal and transverse directions. From the range of parameter values in the table and the model results, it can be seen that the facies control model has higher accuracy than the random interpolation model, which directly confirms the feasibility and effectiveness of the technical system and method proposed in the present disclosure.

TABLE 4
Statistical table of ranges of Young's modulus parameters for random interpolation
modeling and geological - mechanical coupled lithofacies control modeling

| | | Geological - | | | |
|---|---|---|---|---|---|
| | | mechanical coupled | | Random | |
| | | lithofacies control | | interpolation | |
| | | modeling | | modeling | |
| | Type and name of | Minimum | | Minimum | |
| | geological - | value - | | value - | |
| Type and name of | mechanical coupled | maximum | Average | maximum | Average |
| geological lithofacies | lithofacies | value | value | value | value |
| Carbon-rich | Brittle carbon-rich | 0.06-0.67 | 0.64 | 0.12-0.85 | 0.4 |
| medium-high-porosity | medium-high-porosity | | | | |
| siliceous shale | siliceous shale | | | | |
| | Carbon-rich | 0.02-0.86 | | | |
| | medium-high-porosity | | | | |
| | siliceous shale with | | | | |
| | strong shear toughness | | | | |
| | Carbon-rich | 0.16-0.72 | | | |
| | medium-high-porosity | | | | |
| | siliceous shale with | | | | |
| | strong tensile | | | | |
| | toughness | | | | |
| Carbon-rich | Brittle carbon-rich | 0.23-0.94 | 0.69 | 0.08-1 | 0.43 |
| medium-high-porosity | medium-high-porosity | | | | |
| calcium-bearing | calcium-bearing | | | | |
| mud-bearing siliceous | mud-bearing siliceous | | | | |
| shale | shale | | | | |
| | Carbon-rich | 0.19-0.92 | | | |
| | medium-high-porosity | | | | |
| | calcium-bearing | | | | |
| | mud-bearing siliceous | | | | |
| | shale with strong shear | | | | |
| | toughness | | | | |
| | Carbon-rich | 0.53-0.94 | | | |
| | medium-high-porosity | | | | |
| | calcium-bearing | | | | |
| | mud-bearing siliceous | | | | |
| | shale with strong | | | | |
| | tensile toughness | | | | |
| Medium-high-carbon | Brittle | 0.2-0.8 | 0.54 | 0.19-1 | 0.32 |
| medium-high-porosity | medium-high-carbon | | | | |
| siliceous shale | medium-high-porosity | | | | |
| | siliceous shale | | | | |
| | Medium-high-carbon | 0.2-1 | | | |
| | medium-high-porosity | | | | |
| | siliceous shale with | | | | |
| | strong shear toughness | | | | |
| | Medium-high-carbon | 0.7-1 | | | |
| | medium-high-porosity | | | | |
| | siliceous shale with | | | | |
| | strong tensile | | | | |
| | toughness | | | | |
| Medium-low-carbon | Brittle | 0.1-0.8 | 0.74 | 0.02-1 | 0.65 |
| medium-low-porosity | medium-low-carbon | | | | |
| calcium-bearing | medium-low-porosity | | | | |
| argillaceous siliceous | calcium-bearing | | | | |
| shale | argillaceous siliceous | | | | |
| | shale | | | | |
| | Medium-low-carbon | 0.1-1 | | | |
| | medium-low-porosity | | | | |
| | calcium-bearing | | | | |
| | argillaceous siliceous | | | | |
| | shale with strong shear | | | | |
| | toughness | | | | |
| | Medium-low-carbon | 0.4-0.8 | | | |
| | medium-low-porosity | | | | |
| | calcium-bearing | | | | |
| | argillaceous siliceous | | | | |
| | shale with strong | | | | |
| | tensile toughness | | | | |
| Medium-high-carbon | Brittle | 0-0.6 | 0.9 | 0-0.95 | 0.81 |
| medium-high-porosity | medium-high-carbon | | | | |
| mud-bearing siliceous | medium-high-porosity | | | | |
| shale | mud-bearing siliceous | | | | |
| | shale | | | | |
| | Medium-high-carbon | 0.6-0.9 | | | |
| | medium-high-porosity | | | | |
| | mud-bearing siliceous | | | | |
| | shale with strong shear | | | | |
| | toughness | | | | |
| | Medium-high-carbon | 0.8-0.9 | | | |
| | medium-high-porosity | | | | |
| | mud-bearing siliceous | | | | |
| | shale with strong | | | | |
| | tensile toughness | | | | |

On the basis of geological lithofacies classification and identification of shale, the present disclosure systematically carries out rock mechanics and geostress characteristic analysis and identification of the geological lithofacies, and further proposes the construction of a geological-mechanical coupled lithofacies classification system. In this way, the present disclosure forms a comprehensive single-well identification and three-dimensional prediction technology process to characterize the distribution heterogeneity of geological-mechanical characteristics of shale beds in a three-dimensional space, providing a basis for production areas for the exploration and development of artificial oil and gas reservoirs.

What is claimed is:

1. A lithofacies analysis system based on a shale geological-mechanical coupled lithofacies classification system, comprising:
a data acquisition module acquires information data, comprising geological lithofacies data and in-situ mechanics parameter data;
a system construction module connected to the data acquisition module determines a geological-mechanical coupled lithofacies classification system based on the information data;
a prediction module connected to the system construction module performs, by the geological-mechanical coupled lithofacies classification system, single-well quantitative prediction of lithofacies based on logging data, and acquires single-well lithofacies prediction information, wherein the single-well lithofacies prediction information refers to a prediction result of single-well geological-mechanical coupled lithofacies in an entire wellbore space within a range of a bed of interest, and is configured to characterize a facies sequence change characteristic of the single-well geological-mechanical coupled lithofacies along a wellbore;
a feedback adjustment module connected to the prediction module performs feedback adjustment on the single-well lithofacies prediction information based on a set range of a rock mechanics and geostress parameter, and acquires adjustment information;
a three-dimensional model construction module connected to the feedback adjustment module performs, by a genetic algorithm, seismic attribute embedding and integrated inversion based on seismic attribute data and the adjustment information, and constructs, by a collaborative Kriging method, a three-dimensional model for well-seismic collaborative modeling of the geological-mechanical coupled lithofacies, wherein the three-dimensional model is a three-dimensional physical simulation model constructed based on an inherent relationship between respective properties of a geological lithofacies and the geological-mechanical coupled lithofacies, and configured to characterize a mechanical heterogeneity difference and distribution law of the geological lithofacies; and
a parameter model determination module connected to the three-dimensional model construction module and configured to determine, by a layer control-facies control constraint, a geological-mechanical coupled lithofacies control rock mechanics and geostress parameter model based on the three-dimensional model, wherein the parameter model characterizes three-dimensional spatial distribution heterogeneity of a geological-mechanical characteristic of a shale bed, thereby providing a basis for the exploration and development of an artificial oil and gas reservoir in a production area.

2. The lithofacies analysis system based on a shale geological-mechanical coupled lithofacies classification system according to claim 1, wherein the geological-mechanical coupled lithofacies classification system comprises a geological-mechanical coupled lithofacies classification chart and a parameter division standard table of the geological-mechanical coupled lithofacies classification system.

3. The lithofacies analysis system based on a shale geological-mechanical coupled lithofacies classification system according to claim 2, wherein the system construction module comprises:
a processing sub-module connected to the data acquisition module performs data arrangement and singularity removal based on the information data, a positional correspondence principle or similarity and contiguity principle, and a logging response characteristic, so as to acquire arranged data;
a parameter determination sub-module connected to the processing sub-module determines a difference sensitive rock mechanics parameter based on the arranged data, wherein the difference sensitive rock mechanics parameter comprises tensile strength, shear strength, and Young's modulus;
a cluster core determination sub-module connected to the data acquisition module and the parameter determination sub-module separately determines a geological-mechanical coupled lithofacies cluster core based on the information data and the difference sensitive rock mechanics parameter;
an analysis sub-module connected to the cluster core determination sub-module analyzes a boundary and an intersection range of geological-mechanical coupled lithofacies clusters based on the geological-mechanical coupled lithofacies cluster core and determines the boundary and range of the geological-mechanical coupled lithofacies clusters; and
a system determination sub-module, connected to the analysis sub-module, and configured to draw the geological-mechanical coupled lithofacies classification chart based on the boundary and range of the geological-mechanical coupled lithofacies clusters and construct the parameter division standard table of the shale geological-mechanical coupled lithofacies classification system, thereby determining the geological-mechanical coupled lithofacies classification system.

4. The lithofacies analysis system based on a shale geological-mechanical coupled lithofacies classification system according to claim 3, wherein the parameter determination sub-module comprises:
a characteristic attribute determination unit connected to the processing sub-module determines a characteristic attribute through single-factor cluster characteristic extraction and multi-well analogy analysis based on the arranged data;
a distribution difference determination unit connected to the characteristic attribute determination unit performs, based on the characteristic attribute, single-well transverse and multi-well longitudinal attribute consistency checks, respectively, and determines a distribution difference of each type of mechanics parameter on different geological lithofacies; and
a parameter determination unit connected to the distribution difference determination unit determines the difference sensitive rock mechanics parameter based on the distribution difference.

5. A lithofacies analysis method based on a shale geological-mechanical coupled lithofacies classification system, comprising:
acquiring information data, comprising geological lithofacies data and in-situ mechanics parameter data;
determining a geological-mechanical coupled lithofacies classification system based on the information data;
performing, by the geological-mechanical coupled lithofacies classification system, single-well quantitative prediction of lithofacies based on logging data, and acquiring single-well lithofacies prediction information, wherein the single-well lithofacies prediction information refers to a prediction result of single-well geological-mechanical coupled lithofacies in an entire wellbore space within a range of a bed of interest, and is configured to characterize a facies sequence change characteristic of the single-well geological-mechanical coupled lithofacies along a wellbore;
performing feedback adjustment on the single-well lithofacies prediction information based on a set range of a rock mechanics and geostress parameter, and acquiring adjustment information;
performing, by a genetic algorithm, seismic attribute embedding and integrated inversion based on seismic attribute data and the adjustment information, and constructing, by a collaborative Kriging method, a three-dimensional model for well-seismic collaborative modeling of the geological-mechanical coupled lithofacies, wherein the three-dimensional model is a three-dimensional physical simulation model constructed based on an inherent relationship between respective properties of a geological lithofacies and the geological-mechanical coupled lithofacies, and configured to characterize a mechanical heterogeneity difference and distribution law of the geological lithofacies; and
determining, by a layer control-facies control constraint, a geological-mechanical coupled lithofacies control rock mechanics and geostress parameter model based on the three-dimensional model, wherein the parameter model is configured to characterize three-dimensional spatial distribution heterogeneity of a geological-mechanical characteristic of a shale bed, thereby providing a basis for the exploration and development of an artificial oil and gas reservoir in a production area.

6. The lithofacies analysis method based on a shale geological-mechanical coupled lithofacies classification system according to claim 5, wherein the determining a geological-mechanical coupled lithofacies classification system based on the information data further comprises:
performing data arrangement and singularity removal based on the information data, a positional correspondence principle or similarity and contiguity principle, and a logging response characteristic, so as to acquire arranged data;
determining a difference sensitive rock mechanics parameter based on the arranged data, wherein the difference sensitive rock mechanics parameter comprises tensile strength, shear strength, and Young's modulus;
determining a geological-mechanical coupled lithofacies cluster core based on the information data and the difference sensitive rock mechanics parameter;
analyzing a boundary and an intersection range of geological-mechanical coupled lithofacies clusters based on the geological-mechanical coupled lithofacies cluster core, and determining the boundary and range of the geological-mechanical coupled lithofacies clusters; and
drawing the geological-mechanical coupled lithofacies classification chart based on the boundary and range of the geological-mechanical coupled lithofacies clusters, and constructing the parameter division standard table of the geological-mechanical coupled lithofacies classification system, thereby determining the geological-mechanical coupled lithofacies classification system.

7. The lithofacies analysis method based on a shale geological-mechanical coupled lithofacies classification system according to claim 6, wherein the determining a difference sensitive rock mechanics parameter based on the arranged data further comprises:
determining a characteristic attribute through single-factor cluster characteristic extraction and multi-well analogy analysis based on the arranged data;
performing, based on the characteristic attribute, single-well transverse and multi-well longitudinal attribute consistency checks, respectively, and determining a distribution difference of each type of mechanics parameter on different geological lithofacies; and
determining the difference sensitive rock mechanics parameter based on the distribution difference.

8. The lithofacies analysis method based on a shale geological-mechanical coupled lithofacies classification system according to claim 5, wherein the performing, by a genetic algorithm, seismic attribute embedding and integrated inversion based on seismic attribute data and the adjustment information, and constructing, by a collaborative Kriging method, a three-dimensional model for well-seismic collaborative modeling of the geological-mechanical coupled lithofacies further comprises:
determining a genetic neural network architecture parameter, comprising a number of iterations, a correlation threshold, weight decay, and a number of nodes in a hidden layer of a neural network;
extracting, by the genetic algorithm, a single-well seismic attribute data embedding volume based on the genetic neural network architecture parameter and the seismic attribute data;
performing seismic attribute embedding and integrated inversion based on the adjustment information and the single-well seismic attribute data embedding volume to acquire an inversion data volume;
performing data coarsening of the single-well geological lithofacies and geological-mechanical coupled lithofacies, and performing lithofacies data analysis to acquire analyzed data; and
constructing, by the collaborative Kriging method, the three-dimensional model for well-seismic collaborative modeling of the geological-mechanical coupled lithofacies based on a common constraint control of the analyzed data and the inversion data volume.

9. The lithofacies analysis method based on a shale geological-mechanical coupled lithofacies classification system according to claim 5, wherein the determining, by a layer control-facies control constraint, a geological-mechanical coupled lithofacies control rock mechanics and geostress parameter model based on the three-dimensional model further comprises:
acquiring the single-well rock mechanics and geostress parameter;
performing data coarsening and single-layer data analysis based on the single-well rock mechanics and geostress parameter to acquire analyzed parameter data; and
determining, by the layer control-facies control constraint and the collaborative Kriging method, the geological-mechanical coupled lithofacies control rock mechanics and geostress parameter model based on the analyzed parameter data, the single-well rock mechanics and geostress parameter, and the three-dimensional model.

10. The lithofacies analysis method based on a shale geological-mechanical coupled lithofacies classification system according to claim 9, wherein the single-well rock mechanics and geostress parameter is acquired through an experimental means, comprising uniaxial compression, triaxial compression, and point load strength.
